(19) United States
(12) Patent Application Publication
(10) Pub. No.: US 2015/0151717 A1
(43) Pub. Date: Jun. 4, 2015

(54) WIPER/ARM CONNECTION DEVICE, WINDSCREEN WIPER, AND WIPING ASSEMBLY

(71) Applicant: Valeo Systèmes d'Essuyage, Le Mesnil Saint Denis (FR)

(72) Inventors: Patrick Moneyron, Le Cendre (FR); Philippe Espinasse, Coudes (FR); William Terrasse, Vic Le Comte (FR)

(21) Appl. No.: 14/559,581

(22) Filed: Dec. 3, 2014

(30) Foreign Application Priority Data
Dec. 3, 2013 (FR) 1362042

(51) Int. Cl. B60S 1/40

(52) U.S. Cl. CPC B60S 1/4019

(57) ABSTRACT

The invention relates to a connection device (6) for connecting an arm (3) and a windscreen wiper, said device comprising a connection element comprising a connection cavity (7), said connection cavity (7) comprising a transverse shaft (8) designed to cooperate with an end (5) of the actuation arm (3) in order to articulate the windscreen wiper (2) to said actuation arm (3), wherein the transverse shaft (8) comprises at least one cavity (11).

### TECHNICAL FIELD

The present invention relates to a wiper/arm connection device, a windscreen wiper, and a wiping assembly for glazed panels of motor vehicles.

### PRIOR ART

Windscreen wipers comprise connection means enabling said wipers to be coupled to the actuation arms of the motor vehicle. Some connection means are said to be connection means “having a lateral pivot point”. For this, the wiper has a connection cavity comprising a transverse shaft, about which one end of the arm is articulated.

The section of the transverse shaft is inscribed in a relatively large diameter compared with the thickness of the flanks of the connection cavity. These large dimensions of the transverse shaft may pose implementation problems when manufacturing the windscreen wiper. In fact, the cooling at the centre of the transverse shaft may take longer than that of the flanks of the connection cavity, the shrinking induced by this longer cooling potentially risking making the transverse shaft fragile. Also, when moulding the connection cavity, the filling may be incomplete. Micro air bubbles may form at the transverse shaft and may thus make said shaft fragile.

### DISCLOSURE OF THE INVENTION

One of the objectives of the present invention is to propose a wiper/arm connection device, a windscreen wiper, and a wiping assembly for motor vehicles making it possible to form a robust connection cavity in a simple manner.

To this end, the invention relates to a connection device for connecting an arm and a windscreen wiper, said device comprising a connection element comprising a connection cavity, said connection cavity comprising a transverse shaft designed to cooperate with one end of the actuation arm so as to articulate the windscreen wiper to said actuation arm, characterized in that the transverse shaft comprises at least one cavity.

The above-mentioned connection element may be formed by one or more pieces, but is preferably formed in one piece, and in particular is formed in one piece from plastics material.

The cavity in the transverse shaft makes it possible to reduce, in a localized manner, the amount of material necessary to produce the transverse shaft and consequently to reduce the risks of shrinkage during manufacture of the wiper, following cooling of the connection cavity. The strength of the transverse shaft is increased as a result. Also, the cavity or cavities in the transverse shaft makes/make it possible to better distribute the moulding material of the connection cavity, avoiding the formation of air bubbles in the transverse shaft.

Within the context of the invention, the term “cavity in the transverse shaft” means in particular a hollow or empty space in the body of the transverse shaft. It must be understood that the flat portions formed on the surface of the transverse shaft as known in the prior art do not constitute cavities within the context of the invention, in particular because they are aimed neither at preventing moulding shrinkage nor at preventing the formation of air bubbles within the transverse shaft.

In accordance with one feature of the invention, said cavity in the transverse shaft is arranged at a longitudinal end of the transverse shaft.

In accordance with a further feature of the invention, said cavity in the transverse shaft extends from a flank of the connection cavity.

Said cavity in the transverse shaft is advantageously a through-cavity. The term “through” means that said cavity passes through the transverse shaft from one side to the other.

The cavity or cavities in the transverse shaft is/are more preferably localized to the contact zone between the transverse shaft and the flanks of the connection cavity, which makes it possible to reduce the surface of said contact zone.

In accordance with one embodiment, the connection cavity comprises two cavities. The two cavities may be through-cavities. They are, for example, formed one at each end of the transverse shaft, each end being connected to a respective flank of the connection cavity.

In accordance with one embodiment, the primary direction of the at least one cavity in the transverse shaft crosses the central axis of the transverse shaft.

In accordance with one embodiment, the primary direction of the at least one cavity is perpendicular to the central axis of the transverse shaft.

In accordance with one embodiment, the transverse shaft comprises at least one flat portion. Said flat portion is preferably perpendicular to at least one flank of the connection cavity.

In accordance with one embodiment, the primary direction of the at least one cavity in the transverse shaft is parallel to the flat portion.

In accordance with one embodiment, the connection cavity is obtained by moulding, in particular by moulding a plastics material.

The invention also relates to a windscreen wiper comprising a connection device according to any one of the above definitions.

The invention further relates to a wiping assembly, characterized in that it comprises a windscreen wiper as described above and an actuation arm.

### BRIEF DESCRIPTION OF THE DRAWINGS

Further advantages and features will become clearer upon reading the description of a non-limiting exemplary embodiment of the invention and also upon consideration of the accompanying figures, in which:

FIG. 1 shows a schematic view of a windscreen wiper assembled on a motor vehicle arm, in a wiping position,

FIG. 2 shows a perspective view of a connection cavity in the windscreen wiper,

FIG. 3 shows a plan view of a detail of the connection cavity in the windscreen wiper of FIG. 2,

FIG. 4 shows a perspective view of an end of an actuation arm intended to cooperate with the windscreen wiper of FIG. 2,

FIG. 5 shows a schematic sectional view of a wiper/arm connection device in accordance with one exemplary embodiment, in the assembly position,

FIG. 6 shows a view similar to FIG. 5 in a locking position, ready to be disengaged, and

FIG. 7 shows a view similar to FIG. 6 in a locking and wiping position.

In these figures, like or similar elements bear the same reference numerals.

In the following description, the longitudinal, vertical and transverse directions indicated in FIG. 2 by the trihedron (L, V, T) fixed in relation to the wiper will be used by way of non-limiting example. The longitudinal direction L corresponds to the primary direction of windscreen wipers laid flat. With regard to the wiper as illustrated, the horizontal plane corresponds to the plane (L, T).

### DETAILED DESCRIPTION

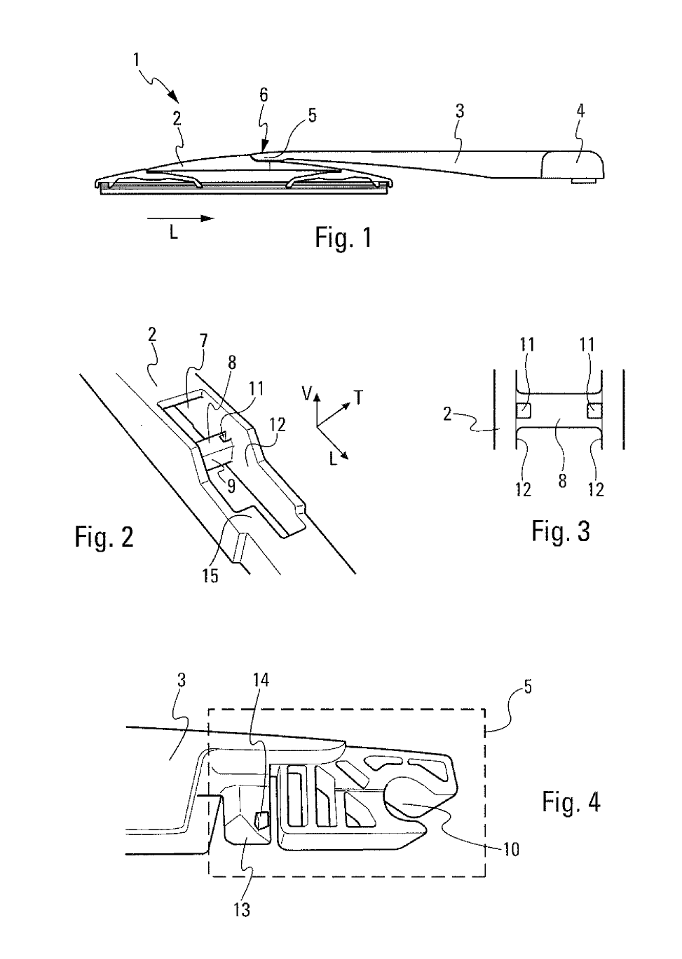

FIGS. 1 to 7 illustrate an exemplary embodiment of a wiping assembly 1 comprising a windscreen wiper 2 for a motor vehicle, coupled to an actuation arm 3. This wiping assembly 1 may be arranged in front of the vehicle in order to wipe the windscreen or may be arranged at the rear in order to wipe the rear window.

The actuation arm 3 comprises a pivoting head 4 intended to be driven in rotation in order to wipe the glazed panel of the vehicle. At the end opposite the pivoting head 4, the actuation arm 3 comprises an end 5 coupled to the windscreen wiper 2 by means of a wiper/arm connection device 6.

As can be seen better in FIG. 2, the wiper/arm connection device 6 comprises a connection element comprising a connection cavity 7.

The connection cavity 7, which for example passes through the thickness of the windscreen wiper 2, is formed substantially in the centre of the wiper 2. The connection cavity 7 extends primarily in the longitudinal primary direction L of the wiper 2, which corresponds to the primary direction of windscreen wipers. The connection cavity 7 is produced by moulding, for example.

The connection cavity 7 comprises a transverse shaft 8 cooperating with the end 5 of the actuation arm 3 so as to articulate the wiper 2 about the arm 3.

The section of the transverse shaft 8 is inscribed in a cylindrical section of greater surface. The transverse shaft 8 comprises, for example, two flat portions 9 parallel to one another and perpendicular to the flanks 12 of the connection cavity 7.

Furthermore, in this example, the transverse shaft 8 comprises at least one cavity 11 arranged at an end of the transverse shaft 8 connected to a flank 12 of the connection cavity 7 (FIG. 3).

The cavities 11 in the transverse shaft 8 are through-cavities which pass through the transverse shaft 8 from one side to the other. They are localized to the contact zone between the transverse shaft 8 and the flanks 12 of the connection cavity 7, which makes it possible to reduce the surface of this contact zone. The risks of shrinkage during the manufacture of the wiper 2, following cooling of the connection cavity 7, are thus avoided, which makes it possible to increase the strength of the transverse shaft 8. The cavities 11 in the transverse shaft 8 also make it possible to better distribute the moulding material of the connection cavity 7, thus avoiding the formation of air bubbles within the transverse shaft 8.

In accordance with one exemplary embodiment illustrated in FIG. 3, the connection cavity 7 comprises two cavities 11 in the transverse shaft 8, each cavity 11 in the transverse shaft 8 being a through cavity formed at a respective end of the transverse shaft 8 connected to a respective flank 12 of the connection cavity 7.

In accordance with one embodiment, the cavity 11 in the transverse shaft 8 extends in the vertical direction V, parallel to the flat portions 9, such that the primary direction of the cavity 11 in the transverse shaft 8 crosses the central axis of the transverse shaft 8 perpendicularly.

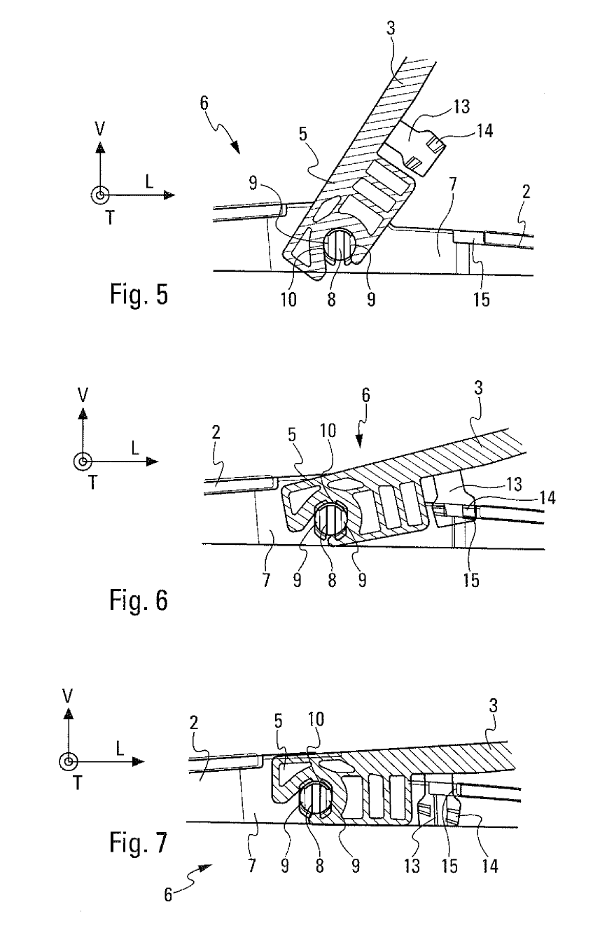

With reference to FIG. 4, the end 5 of the actuation arm 3 comprises a partially cylindrical articulation seat 10 complementary to the cylindrical portion of the transverse shaft 8 of the wiper 2. The opening of the articulation seat 10 coincides with the narrowest dimension of the section of the transverse shaft 8. Thus, when the transverse shaft 8 of the wiper 2 is brought towards the end 5 of the actuation arm 3 with the appropriate orientation, the transverse shaft 8 of the wiper 2 may be received in the articulation seat 10 (FIG. 5). In this position, referred to as the assembly position, the wiper 2 can pivot about the actuation arm 3 to which it is articulated and can be detached form the arm 3.

The wiper 2 may also adopt a locking position (FIGS. 6 and 7), in which the pivoting of the wiper 2 about the actuation arm 3 is limited, which prevents the reversal of the wiper 2 against the glazed panel or the loss of the wiper 2, for example as the wiper 2 is cleaned. In this locking position, the wiper 2 and the actuation arm 3 can adopt the wiping position or the disengaged position.

In accordance with one exemplary embodiment, the actuation arm 3 may comprise a flexible tongue 13 at the rear of the articulation seat 10, comprising one or more locking tabs 14. The tongue 13 cooperates by resilient deformation with the connection cavity 7 of the wiper 2 in a locking position so that the pivoting of the wiper 2 relative to the arm 3 is limited. The transfer into the locking position is performed manually by forcibly mounting the flexible tongue 13 in a slot in the connection cavity 7. The pivoting of the windscreen wiper 2 is limited relative to the actuation arm 3 by placing one or more locking tabs 14 in abutment against an upper wall 15 of the slot in the connection cavity 7.

Thus, in the assembly position illustrated in FIG. 5, the tongue 13 is at a distance from the connection cavity 7.

In the locking position illustrated by FIGS. 6 and 7, the pivoting of the windscreen wiper 2 relative to the actuation arm 3 is limited by placing the locking tab 13 in abutment against the connection cavity 7. The windscreen wiper 2 cannot escape from the actuation arm 3.

In the wiping position (FIG. 7), the primary direction of the windscreen wiper 2 extends substantially in the same direction as that of the actuation arm 3. The locking tab 14 is not in abutment with the connection cavity 7. The windscreen wiper 2 is thus free to pivot about the transverse shaft 8 with a limited angle between the wiping position and an abutment position, referred to as “ready to be disengaged”, which ensures the anti-reversal of the wiper.

1. A connection device for connecting an arm and a windscreen wiper, said device comprising:
a connection element comprising a connection cavity, said connection cavity comprising a transverse shaft designed to cooperate with an end of the actuation arm to articulate the windscreen wiper to said actuation arm,
wherein the transverse shaft comprises at least one cavity.

2. The connection device according to claim 1, wherein said cavity in the transverse shaft is arranged at a longitudinal end of the transverse shaft.

3. The connection device according to claim 1, wherein said cavity in the transverse shaft extends from a flank of the connection cavity.

4. The connection device according to claim 1, wherein said cavity in the transverse shaft is a through-cavity.

5. The connection device according to claim 1, wherein the transverse shaft comprises two cavities.

6. The connection device according to claim 5, wherein the cavities in the transverse shaft are through-cavities.

7. The connection device according to claim 5, wherein the cavities in the transverse shaft are formed one at each end of the transverse shaft, each end being connected to a respective flank of the connection cavity.

8. The connection device according to claim 1, wherein the primary direction of the at least one cavity in the transverse shaft crosses the central axis of the transverse shaft.

9. The connection device according to claim 1, wherein the primary direction of the at least one cavity is perpendicular to the central axis of the transverse shaft.

10. The connection device according to claim 1, wherein the transverse shaft comprises at least one flat portion.

11. The connection device according to claim 10, wherein said flat portion is perpendicular to at least one flank of the connection cavity.

12. The connection device according to claim 8, wherein the primary direction of the at least one cavity in the transverse shaft is parallel to the flat portion.

13. The connection device according to claim 1, wherein the connection cavity is produced by moulding a plastics material.

14. A windscreen wiper comprising a connection device according to claim 1.

15. A wiping assembly comprising a windscreen wiper according to claim 14 and an actuation arm.
